(19) United States
(12) Patent Application Publication
(10) Pub. No.: US 2020/0258050 A1
(43) Pub. Date: Aug. 13, 2020

(54) TOKEN-BASED CALENDAR ACCESS AND CONFLICT CLEARANCE

(71) Applicant: INTERNATIONAL BUSINESS MACHINES CORPORATION, Armonk, NY (US)

(72) Inventors: Barbara Elizabeth WANG, Austin, TX (US); Priya Ajay INGLE, Austin, TX (US); Sangeetha SRIKANTH, Austin, TX (US); Johnny SHIEH, Austin, TX (US); Leslie LUNDQUIST, Auburn, WA (US)

(21) Appl. No.: 16/272,856

(22) Filed: Feb. 11, 2019

(51) Int. Cl. G06Q 10/10; H04L 9/32

(52) U.S. Cl. CPC G06Q 10/1095; H04L 9/3228; H04L 9/3213

(57) ABSTRACT

Computer-implemented methods, systems, and computer program products are disclosed in which a first computing device sends a meeting request for person(s) to a second computing device. The first computing device receives from the second computing device, first token(s) granting limited access to calendar information for the person(s) sufficient for conflict clearance, the token(s) having restriction(s). The restriction(s) include one or more of a lifespan for the limited access, an identification of which calendar entries are accessible, an indication of how much of a calendar entry is accessible, a use count for the limited access, showing only available time and encryption of the calendar information. The first computing device sends to the second computing device, a meeting invitation for the person(s) based on the limited access. The first computing device then receives from the second computing device, an acceptance for the meeting invitation.

### BACKGROUND

Solutions exist to resolve calendar conflicts. For example, some calendaring applications share a built in conflict resolution feature that allows users within an organization to check to see if an invitee is able to attend a meeting. If not, the tool may further show open time slots that the invitee may be invited to instead, that does not conflict with the originator's own schedule.

However, scheduling a meeting between organizations (e.g., companies) is still done by back-and-forth communications between the organizations. In one scenario, for example, a meeting originator must send an email to the representatives of the third party company and ask them to scour their calendar conflict system and then send open “slots” where they are available. This often leads to confusion as there may be issues with what time zone various users reside and if the calendar of certain people scanned at the third party company has changed between the scan and the delivery of this information to the originator of the common meeting invitation.

### SUMMARY

Shortcomings of the prior art are overcome and additional advantages are provided through the provision, in one aspect, of a computer-implemented method of scheduling a meeting. The method includes: sending, from a first computing device to a second computing device, a meeting request for at least one person; receiving, by the first computing device from the second computing device, at least one first token granting limited access to calendar information for the at least one person sufficient for conflict clearance, the at least one token comprising at least one restriction; wherein the at least one restriction comprises at least one of a lifespan for the limited access, an identification of which calendar entries are accessible, a use count for the limited access, or permission for the first computing device to receive access to calendar information updates for the at least one person made after receiving the at least one first token by the first computing device. The method further includes: processing, by the first computing device, the at least one first token to gain the limited access to the calendar information for the at least one person, subject to the at least one restriction; sending, from the first computing device to the second computing device, a meeting invitation for the at least one person based on the limited access; and receiving, by the first computing device from the second computing device, an acceptance for the meeting invitation.

In another aspect, a system for scheduling a meeting may be provided. The system may include, for example, memory(ies), at least one processor in communication with the memory(ies). The memory(ies) include program instructions executable by the one or more processors to perform a method. The method may include, for example: sending, from a first computing device to a second computing device, a meeting request for at least one person; receiving, by the first computing device from the second computing device, at least one first token granting limited access to calendar information for the at least one person sufficient for conflict clearance, the at least one token comprising at least one restriction; wherein the at least one restriction comprises at least one of a lifespan for the limited access, an identification of which calendar entries are accessible, a use count for the limited access, or permission for the first computing device to receive access to calendar information updates for the at least one person made after receiving the at least one first token by the first computing device. The method further includes: processing, by the first computing device, the at least one first token to gain the limited access to the calendar information for the at least one person, subject to the at least one restriction; sending, from the first computing device to the second computing device, a meeting invitation for the at least one person based on the limited access; and receiving, by the first computing device from the second computing device, an acceptance for the meeting invitation.

In a further aspect, a computer program product may be provided. The computer program product may include a storage medium readable by a processor and storing instructions executable by the processor for performing a method of scheduling a meeting. The method may include, for example: sending, from a first computing device to a second computing device, a meeting request for at least one person; receiving, by the first computing device from the second computing device, at least one first token granting limited access to calendar information for the at least one person sufficient for conflict clearance, the at least one token comprising at least one restriction; wherein the at least one restriction comprises at least one of a lifespan for the limited access, an identification of which calendar entries are accessible, a use count for the limited access, or permission for the first computing device to receive access to calendar information updates for the at least one person made after receiving the at least one first token by the first computing device. The method further includes: processing, by the first computing device, the at least one first token to gain the limited access to the calendar information for the at least one person, subject to the at least one restriction; sending, from the first computing device to the second computing device, a meeting invitation for the at least one person based on the limited access; and receiving, by the first computing device from the second computing device, an acceptance for the meeting invitation.

Services relating to one or more aspects of this disclosure are also described and may be claimed herein.

Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 is a flow diagram for one example of a computer-implemented method of scheduling a meeting, in accordance with one or more aspects of the present disclosure;

FIG. 2 is a flow diagram for one example for granting limited access to calendar information for conflict clearance, in accordance with one or more aspects of the present disclosure;

FIG. 3 is a flow diagram for one example of scheduling a meeting between three computing devices, in accordance with one or more aspects of the present disclosure;

FIG. 4 is a modified flow diagram for one example of an alternate way of granting limited access to calendar information for conflict clearance, in accordance with one or more aspects of the present disclosure;

FIG. 5 is a block diagram of one example of a computer system, in accordance with one or more aspects of the present disclosure;

FIG. 6 is a block diagram of one example of a cloud computing environment, in accordance with one or more aspects of the present disclosure; and

FIG. 7 is a block diagram of one example of functional abstraction layers of the cloud computing environment of FIG. 6, in accordance with one or more aspects of the present disclosure.

### DETAILED DESCRIPTION

One or more aspects of this disclosure relate, in general, to conflict clearance in scheduling a meeting. More particularly, one or more aspects of this disclosure relate to conflict clearance among different entities, for example, different companies.

In accordance with one or more aspects of the present invention, disclosed herein is a way to do conflict clearance among different entities (defined herein) using limited calendar access granted to a meeting organizer, the limited access including, for example, access limitations based on privacy or confidentiality concerns.

As used herein, the term “limited access” refers to a level of access to calendar information that is less than a level of access to the calendar information made available to one or more other users. Limited access can be based on privacy concerns. For example, limited access could be access to an indication on another's calendar of not available or available, as opposed to full details of scheduled meetings. As another example, the limited access could have an expiration, a number of allowed uses or other access stipulations.

As used herein, the term “restriction(s)” refers to a level of access to calendar information considered by an entity and/or a person that is associated with the entity (e.g., an employee or other member of a recognized organization or group, for example, a legally recognized business entity or government agency) to be an acceptable level of access. Thus, the extent of “restriction(s)” is individualized to the entity and/or a person associated with the entity.

As used herein, the term “calendar application” refers to an electronic calendar (e.g., program, application, etc.) for keeping one or more aspects of one's schedule, for example, days working, days not working, holidays, vacation, meetings, appointments, etc.

As used herein, the term “token” when used with respect to a calendar application, refers to electronic information packaged for use by a data processing system giving limited access to calendar information of one or more persons. For example, the token can take the form of a flat file (e.g., an XML file) or information in a standard calendar format (e.g., ICS format).

iCalendar is a computer file format which allows Internet users to send meeting requests and tasks to other Internet users by sharing or sending files in this format through various methods. The files usually have an extension of .ics, .ical, .ifb or .icalendar. With a supporting application, such as a calendar application, recipients of an iCalendar data file can respond to the sender easily or counter-propose another meeting date/time.

iCalendar is designed to be independent of the transport protocol. For example, certain events can be sent by traditional email or whole calendar files can be shared and edited by using a WebDav server, or SyncML. Simple web servers (using just the HTTP protocol) are often used to distribute iCalendar data about an event and to publish busy times of an individual. Publishers can embed iCalendar data in web pages using hCalendar, a 1:1 microformat representation of iCalendar in semantic (X)HTML.

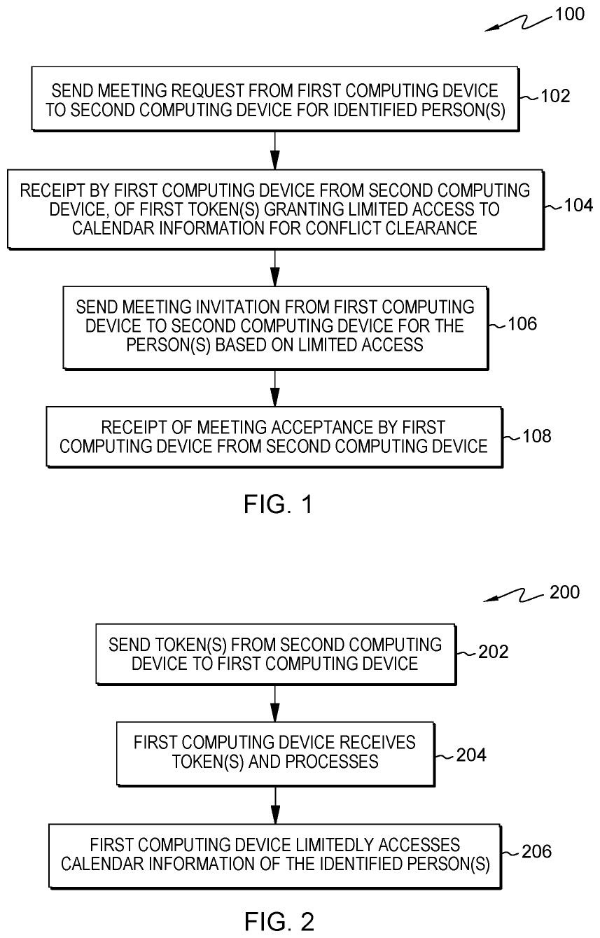

FIG. 1 is a flow diagram 100 for one example of a computer-implemented method of scheduling a meeting, in accordance with one or more aspects of the present disclosure. The computer-implemented method begins by sending 102 a meeting request from a first computing device to a second computing device for identified person(s). The first computing device then receives 104, from the second computing device, first token(s) granting limited access to calendar information of the identified person(s) sufficient for conflict clearance. A meeting invitation is then sent 106 from the first computing device to the second computing device for the identified person(s) based on the limited access granted. The first computing device then receives a meeting invitation acceptance from the second computing device. Permission or authority is in place to grant access to calendar information of the identified person(s). For example, a proxy agreement may have been obtained from the identified person(s), in which each identified person may have set forth restrictions or options desired from a set of restrictions. For example, one person may only allow a meeting organizer to see busy/available indicators only for a set time period with no access to details. Another person may, for example, allow access to, for example, a busy indicator, including whether the person has a meeting in the office or outside the office. Still another person may, for example, allow access only a certain number of times, after which access is terminated. There may also be, instead or in addition, common preselected restrictions that may be used, for example, by a manager of the identified person(s). Based on the limited access, a possible time is selected that all the meeting participants are available and a meeting invitation is sent, or, in another example, it is allowed to add the meeting to a given identified person's calendar, for example, with notice to the person.

FIG. 2 is a flow diagram 200 for one example for granting limited access to calendar information sufficient for conflict clearance, in accordance with one or more aspects of the present disclosure. First computing device receives 204 a token from the second computing device and processes it. The token includes the limited access 206 to the calendar information of identified person(s), which allows the first computing device to at least do a conflict clearance, i.e., find one or more times that all the meeting participants are available. Once a day/time for meeting is found, meeting invitation(s) go out to each of the one or more persons or to a common recipient. In one embodiment, the invitations go out automatically once the first computing device chooses a day/time. In another embodiment, the first computing device manually creates and sends the electronic invitations from the first computing device's calendaring application. The token can take different forms, for example, the form of a flat file (e.g., standard XML (Extensible Markup Language) file), “.ics” file, “.ical” file, HTML or other standard calendar input format.

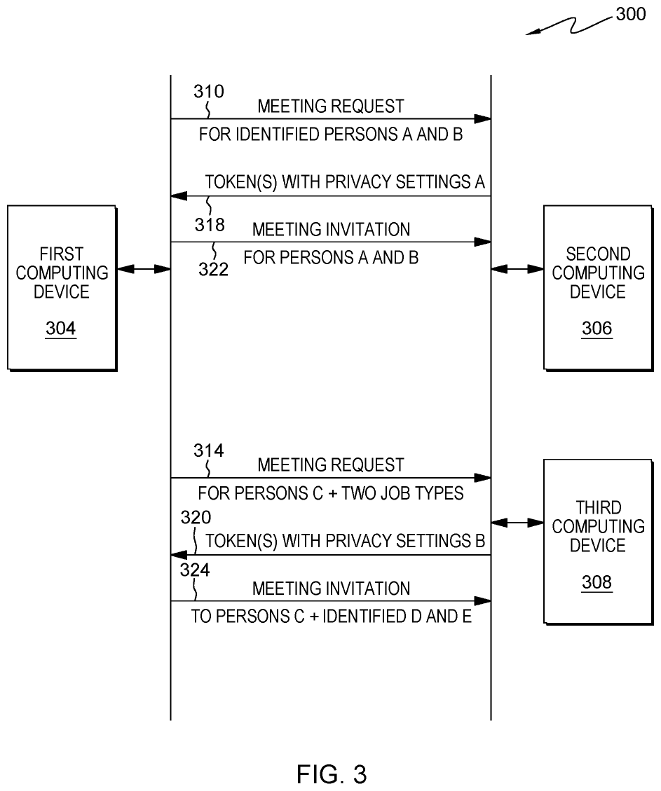

FIG. 3 is a flow diagram 300 for one example of scheduling a meeting using three computing devices, in accordance with one or more aspects of the present disclosure. In one example, each of the three computing devices is associated with, for example, a group, a business or a government entity different than the other two computing devices. A first computing device 304 is used to schedule a meeting, for example, in the next two weeks with, for example, two people associated with a second computing device 306 and three people associated with a third computing device 308. The first computing device sends 310 a meeting request using a first calendaring application for person A and person B to the second computing device. The first computing device also sends 314 a meeting request to the third computing device for a kernel expert (i.e., not a specific person), a storage expert and person C, all three associated with the third computing device. In response to the request, in one example, a user associated with the second computing device starts a calendar token generating plugin to a second calendaring application to check the calendars of persons A and B for availability in the next three weeks (in case the next two weeks is insufficient), although it could just be the two weeks or another time frame. After receiving the results of the calendar check, the user associated with the second computing device then sets 318 the following example privacy settings or restrictions A in the token: the content (i.e., details of the meeting) for meeting conflicts of persons A and B's calendars is blocked—anyone that uses the token will only see that the time is blocked without details; a lifetime for the token is one week and can only be used for calendar conflict resolution; and the token will allow “live” updates to the calendars of persons A and B (i.e., any changes to their calendars during the week are visible to the first user). Another user associated with the third computing device follows a similar token generation process before sending 320, except that specific persons need to be chosen for the kernel expert and the storage expert (the “two job types” in meeting request 314). Also, the restrictions for the people associated with the third computing device are different from that of the people associated with the second computing device; namely, the token's lifetime is set to be 24 hours, there are no live updates allowed and only a particular user associated with the first computing device can access (i.e., the token is encrypted). Upon receipt by the first computing device, the tokens are input into a buffer of the first calendaring application conflict plugin, which allows the user to use a calendar conflict tool native to their calendar application to find available times as if the requested people were also associated with the first computing unit. When the user associated with the first computing device settles on a mutually available day/time, invitations to the meeting are sent 322 to second computing device 306 and sent 324 to third computing device 308. In this example, the email addresses of the requested people are included in the tokens, but the invitations could be automatically sent or manually sent.

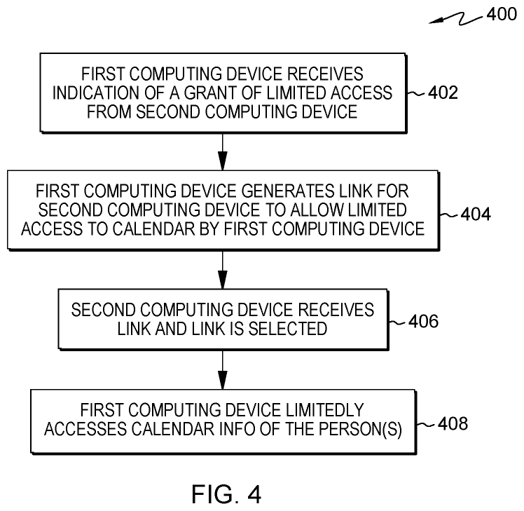

FIG. 4 is a flow diagram 400 for one example of an alternate way of granting limited access to calendar information for conflict clearance, in accordance with one or more aspects of the present disclosure. The first computing device receives an indication 402 from the second computing device that limited access to the calendaring information of the identified person(s) is granted. The first computing device then generates 404 a link (e.g., in the form of a “grant” or other selector, e.g., a button) for sending to the second computing device that, when selected 406 at the second computing device, will allow the limited access to calendar information of the identified person(s) to the first computing device. Limited access 408 to the calendar information of the identified person(s) is now available to the first computing device.

In a first aspect, disclosed above is a computer-implemented method for scheduling a meeting. The computer-implemented method includes: sending, from a first computing device to a second computing device, a meeting request for person(s); receiving, by the first computing device from the second computing device, first token(s) granting limited access to calendar information for the person(s) sufficient for conflict clearance, the token(s) comprising restriction(s); the restriction(s) may include, for example, at least one of a lifespan for the limited access, an identification of which calendar entries are accessible, a use count for the limited access, or permission for the first computing device to receive access to calendar information updates for the person(s) made after receiving the first token(s) by the first computing device. The method further includes: processing, by the first computing device, the first token(s) to gain the limited access to the calendar information for the person(s), subject to the restriction(s); sending, from the first computing device to the second computing device, a meeting invitation for the person(s) based on the limited access; and receiving, by the first computing device from the second computing device, an acceptance for the meeting invitation.

In one example, first computing device may use, for example, a first calendar application and the second computing device may use, for example, a second calendar application different from the first calendar application.

In one example, the first token(s) of the computer-implemented method of the first aspect may include, for computer file(s).

In one example, a calendar application plugin of the second computing device of the computer-implemented method of the first aspect may generate, for example, the first token(s).

In one example, the token(s) may include, for example, link(s) that, when selected, allows the limited access.

In one example, the restriction(s) of the computer-implemented method of the first aspect may include, for example, individual restriction(s) for one or more of the person(s).

In one example, the restriction(s) of the computer-implemented method of the first aspect may include, for example, common restriction(s) for two or more of the person(s).

In one example, the person(s) of the computer-implemented method of the first aspect may include, for example, person(s) and job type(s), and the token(s) identify other person(s) for the job type(s).

In one example, the receipt of the first token(s) in the computer-implemented method of the first aspect further allows a calendar conflict tool native to the first computing device to search the calendar information of the person(s) as if associated with the first computing device.

In a second aspect, disclosed above is a system for scheduling a meeting. The system includes: a memory; and processor(s) in communication with the memory, the memory storing program code executable by the processor(s) to perform a method, the method including: sending, from a first computing device to a second computing device, a meeting request for person(s); receiving, by the first computing device from the second computing device, first token(s) granting limited access to calendar information for the person(s) sufficient for conflict clearance, the token(s) comprising restriction(s); the restriction(s) may include, for example, at least one of a lifespan for the limited access, an identification of which calendar entries are accessible, a use count for the limited access, or permission for the first computing device to receive access to calendar information updates for the person(s) made after receiving the first token(s) by the first computing device. The method further includes: processing, by the first computing device, the first token(s) to gain the limited access to the calendar information for the person(s), subject to the restriction(s); sending, from the first computing device to the second computing device, a meeting invitation for the person(s) based on the limited access; and receiving, by the first computing device from the second computing device, an acceptance for the meeting invitation.

In one example, the first computing device of the system of the second aspect may use, for example, a first calendar application and the second computing device may use, for example, a second calendar application different from the first calendar application.

In one example, the first token(s) of the system of the second aspect may include, for example, link(s) that, when selected, allows the limited access.

In one example, the restriction(s) of the system of the second aspect may include, for example, at least one of: one or more individual restriction(s); and common restriction(s) for two or more of the persons.

In a third aspect, disclosed above is a computer program product for scheduling a meeting. The computer program product includes: a storage medium readable by a processor and storing instructions executable by the processor for performing a method of scheduling a meeting, the method including: sending, from a first computing device to a second computing device, a meeting request for person(s); receiving, by the first computing device from the second computing device, first token(s) granting limited access to calendar information for the person(s) sufficient for conflict clearance, the token(s) comprising restriction(s); the restriction(s) may include, for example, at least one of a lifespan for the limited access, an identification of which calendar entries are accessible, a use count for the limited access, or permission for the first computing device to receive access to calendar information updates for the person(s) made after receiving the first token(s) by the first computing device. The method further includes: processing, by the first computing device, the first token(s) to gain the limited access to the calendar information for the person(s), subject to the restriction(s); sending, from the first computing device to the second computing device, a meeting invitation for the person(s) based on the limited access; and receiving, by the first computing device from the second computing device, an acceptance for the meeting invitation.

In one example, the first computing device of the computer program product of the third aspect may use, for example, a first calendar application and the second computing device may use, for example, a second calendar application different from the first calendar application.

In one example, the first token(s) of the computer program product of the third aspect may include, for example, link(s) that, when selected, allows the limited access.

In one example, the restriction(s) of the computer program product of the third aspect may include, for example, at least one of: individual restriction(s); and common restriction(s) for two or more of the persons.

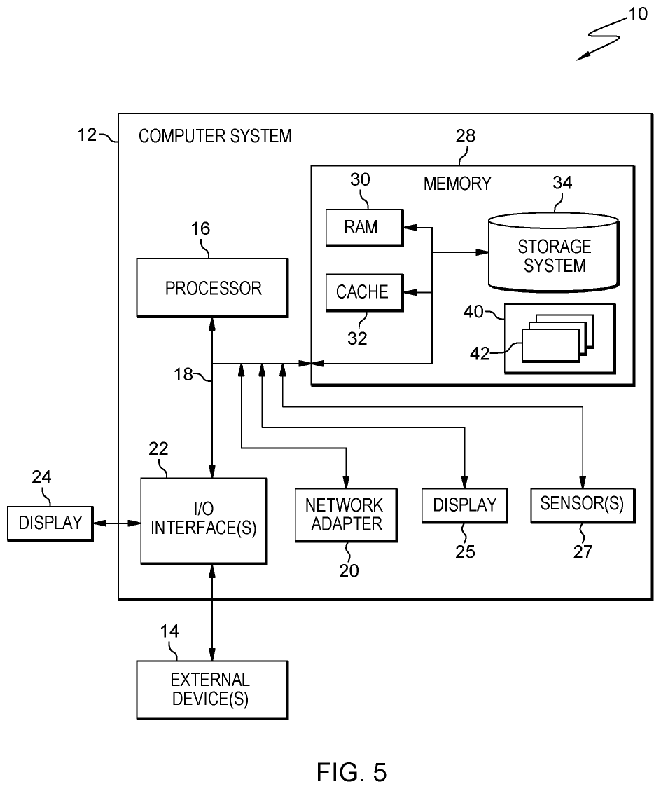

FIGS. 5-7 depict various aspects of computing, including a computer system and cloud computing, in accordance with one or more aspects set forth herein.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 5, a schematic of an example of a computing node is shown. Computing node 10 is only one example of a computing node suitable for use as a cloud computing node and is not intended to suggest any limitation as to the scope of use or functionality of embodiments of the invention described herein. Regardless, computing node 10 is capable of being implemented and/or performing any of the functionality set forth hereinabove. Computing node 10 can be implemented as a cloud computing node in a cloud computing environment, or can be implemented as a computing node in a computing environment other than a cloud computing environment.

In computing node 10 there is a computer system 12, which is operational with numerous other general purpose or special purpose computing system environments or configurations. Examples of well-known computing systems, environments, and/or configurations that may be suitable for use with computer system 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system 12 may be described in the general context of computer system-executable instructions, such as program processes, being executed by a computer system. Generally, program processes may include routines, programs, objects, components, logic, data structures, and so on that perform particular tasks or implement particular abstract data types. Computer system 12 may be practiced in distributed cloud computing environments where tasks are performed by remote processing devices that are linked through a communications network. In a distributed cloud computing environment, program processes may be located in both local and remote computer system storage media including memory storage devices.

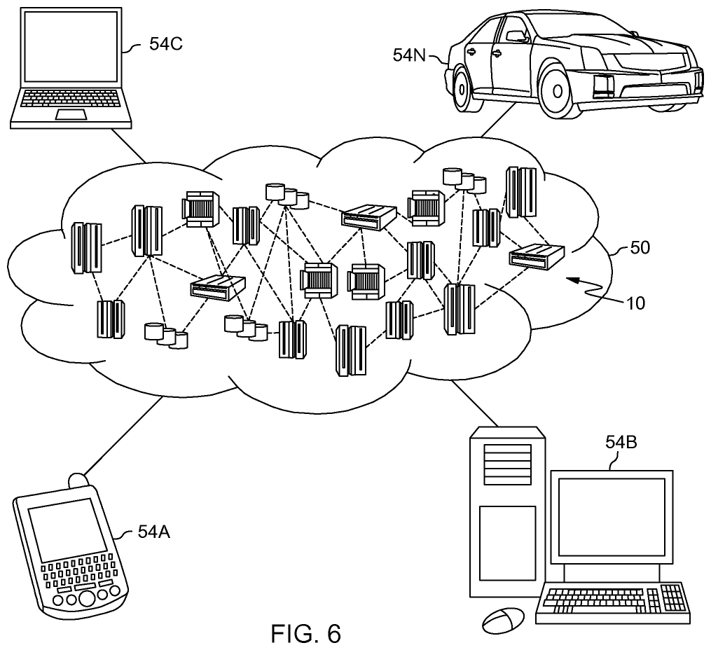

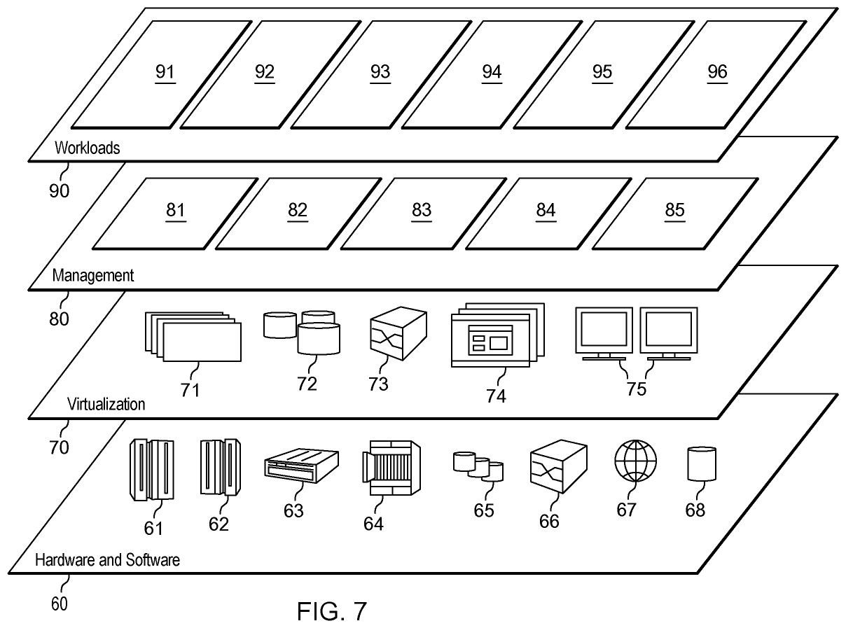

As shown in FIG. 5, computer system 12 in computing node 10 is shown in the form of a computing device. The components of computer system 12 may include, but are not limited to, one or more processors 16, a system memory 28, and a bus 18 that couples various system components including system memory 28 to processor 16. In one embodiment, computing node 10 is a computing node of a non-cloud computing environment. In one embodiment, computing node 10 is a computing node of a cloud computing environment as set forth herein in connection with FIGS. 6-7.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system 12 typically includes a variety of computer system readable media. Such media may be any available media that is accessible by computer system 12, and it includes both volatile and non-volatile media, removable and non-removable media.

System memory 28 can include computer system readable media in the form of volatile memory, such as random access memory (RAM) 30 and/or cache memory 32. Computer system 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program processes that are configured to carry out the functions of embodiments of the invention.

One or more programs 40, having a set (at least one) of program processes 42, may be stored in memory 28 by way of example, and not limitation, as well as an operating system, one or more application programs, other program processes, and program data. One or more programs 40 including program processes 42 can generally carry out the functions set forth herein. One or more programs 40 including program processes 42 can define machine logic to carry out the functions set forth herein.

Computer system 12 may also communicate with one or more external devices 14 such as a keyboard, a pointing device, a display 24, etc.; one or more devices that enable a user to interact with computer system 12; and/or any devices (e.g., network card, modem, etc.) that enable computer system 12 to communicate with one or more other computing devices. Such communication can occur via Input/Output (I/O) interfaces 22. Still yet, computer system 12 can communicate with one or more networks such as a local area network (LAN), a general wide area network (WAN), and/or a public network (e.g., the Internet) via network adapter 20. As depicted, network adapter 20 communicates with the other components of computer system 12 via bus 18. It should be understood that although not shown, other hardware and/or software components could be used in conjunction with computer system 12. Examples, include, but are not limited to: microcode, device drivers, redundant processing units, external disk drive arrays, RAID systems, tape drives, and data archival storage systems, etc. In addition to or in place of having external devices 14 and display 24, which can be configured to provide user interface functionality, computing node 10 in one embodiment can include display 25 connected to bus 18. In one embodiment, display 25 can be configured as a touch screen display and can be configured to provide user interface functionality, e.g. can facilitate virtual keyboard functionality and input of total data. Computer system 12 in one embodiment can also include one or more sensor devices 27 connected to bus 18. One or more sensor devices 27 can alternatively be connected through I/O interface(s) 22. One or more sensor devices 27 can include a Global Positioning Sensor (GPS) device in one embodiment and can be configured to provide a location of computing node 10. In one embodiment, one or more sensor devices 27 can alternatively or in addition include, e.g., one or more of a camera, a gyroscope, a temperature sensor, a humidity sensor, a pulse sensor, a blood pressure (bp) sensor or an audio input device. Computer system 12 can include one or more network adapters 20. In FIG. 6 computing node 10 is described as being implemented in a cloud computing environment and accordingly is referred to as a cloud computing node in the context of FIG. 6.

Referring now to FIG. 6, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 6 are intended to be illustrative only and that computing nodes 10 and cloud computing environment 50 can communicate with any type of computerized device over any type of network and/or network addressable connection (e.g., using a web browser).

Referring now to FIG. 7, a set of functional abstraction layers provided by cloud computing environment 50 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and processing components 96 for establishing and updating geofence locations as set forth herein. The processing components 96 can be implemented with use of one or more programs 40 described in FIG. 5.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of a device that “comprises,” “has,” “includes,” or “contains” one or more features possesses those one or more features, but is not limited to possessing only those one or more features. Forms of the term “based on” herein encompass relationships where an element is partially based on as well as relationships where an element is entirely based on. Methods, products and systems described as having a certain number of elements can be practiced with less than or greater than the certain number of elements. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description set forth herein has been presented for purposes of illustration and description, but is not intended to be exhaustive or limited to the form disclosed. Many modifications and variations will be apparent to those of ordinary skill in the art without departing from the scope and spirit of the disclosure. The embodiment was chosen and described in order to best explain the principles of one or more aspects set forth herein and the practical application, and to enable others of ordinary skill in the art to understand one or more aspects as described herein for various embodiments with various modifications as are suited to the particular use contemplated.

What is claimed is:

1. A computer-implemented method, the computer-implemented method comprising:
sending, from a first computing device to a second computing device, a meeting request for at least one person;
receiving, by the first computing device from the second computing device, at least one first token granting limited access to calendar information for the at least one person sufficient for conflict clearance, the at least one token comprising at least one restriction, wherein the at least one restriction comprises at least one of a lifespan for the limited access, an identification of which calendar entries are accessible, a use count for the limited access, or permission for the first computing device to receive access to calendar information updates for the at least one person made after receiving the at least one first token by the first computing device;
processing, by the first computing device, the at least one first token to gain the limited access to the calendar information for the at least one person, subject to the at least one restriction;
sending, from the first computing device to the second computing device, a meeting invitation for the at least one person based on the limited access; and
receiving, by the first computing device from the second computing device, an acceptance for the meeting invitation.

2. The computer-implemented method of claim 1, wherein the first computing device uses a first calendar application and wherein the second computing device uses a second calendar application different from the first calendar application.

3. The computer-implemented method of claim 1, wherein the at least one first token comprises at least one computer file.

4. The computer-implemented method of claim 1, wherein a calendar application plugin of the second computing device generates the at least one first token.

5. The computer-implemented method of claim 1, wherein the at least one first token comprises at least one link that, when selected, allows the limited access.

6. The computer-implemented method of claim 1, wherein the at least one restriction comprises one or more individual restrictions for one or more of the at least one person.

7. The computer-implemented method of claim 1, wherein at least one restriction comprises one or more common restrictions for two or more of the at least one person.

8. The computer-implemented method of claim 1, wherein the at least one person comprises one or more persons and at least one job type, and wherein the at least one token identifies at least one other person for the at least one job type.

9. The computer-implemented method of claim 1, wherein the receipt of the at least one first token further allows a calendar conflict tool native to the first computing device to search the calendar information of the at least one person as if associated with the first computing device.

10. A system, the system comprising:
a memory; and
at least one processor in communication with the memory, the memory storing program code executable by the at least one processor to perform a method, the method comprising:
sending, from a first computing device to a second computing device, a meeting request for at least one person;
receiving, by the first computing device from the second computing device, at least one first token granting limited access to calendar information for the at least one person sufficient for conflict clearance, the at least one token comprising at least one restriction, wherein the at least one restriction comprises at least one of a lifespan for the limited access, an identification of which calendar entries are accessible, a use count for the limited access, or permission for the first computing device to receive access to calendar information updates for the at least one person made after receiving the at least one first token by the first computing device;
processing, by the first computing device, the at least one first token to gain the limited access to the calendar information for the at least one person, subject to the at least one restriction;
sending, from the first computing device to the second computing device, a meeting invitation for the at least one person based on the limited access; and
receiving, by the first computing device from the second computing device, an acceptance for the meeting invitation.

11. The system of claim 10, wherein the first computing device uses a first calendar application and wherein the second computing device uses a second calendar application different from the first calendar application.

12. The system of claim 10, wherein the at least one first token comprises at least one link that, when selected, allows the limited access.

13. The system of claim 10, wherein the at least one restriction comprises at least one of: one or more individual restrictions and one or more common restrictions for two or more of the at least one person.

14. A computer program product, the computer program product comprising:
a storage medium readable by a processor and storing instructions executable by the processor for performing a method of scheduling a meeting, the method comprising:
sending, from a first computing device to a second computing device, a meeting request for at least one person;
receiving, by the first computing device from the second computing device, at least one first token granting limited access to calendar information for the at least one person sufficient for conflict clearance, the at least one token comprising at least one restriction, wherein the at least one restriction comprises at least one of a lifespan for the limited access, an identification of which calendar entries are accessible, a use count for the limited access, or permission for the first computing device to receive access to calendar information updates for the at least one person made after receiving the at least one first token by the first computing device;
processing, by the first computing device, the at least one first token to gain the limited access to the calendar information for the at least one person, subject to the at least one restriction;
sending, from the first computing device to the second computing device, a meeting invitation for the at least one person based on the limited access; and
receiving, by the first computing device from the second computing device, an acceptance for the meeting invitation.

15. The computer program product of claim 14, wherein the first computing device uses a first calendar application and wherein the second computing device uses a second calendar application different from the first calendar application.

16. The computer program product of claim 14, wherein the at least one first token comprises at least one link that, when selected, allows the limited access.

17. The computer program product of claim 14, wherein the at least one restriction comprises at least one of: one or more individual restrictions and one or more common restrictions for two or more of the at least one person.
